(19) United States
(12) Patent Application Publication
(10) Pub. No.: US 2026/0024879 A1
(43) Pub. Date: Jan. 22, 2026

(54) BUS BAR HAVING A MECHANICAL FUSE

(71) Applicant: GM Global Technology Operations LLC, Detroit, MI (US)

(72) Inventors: Hui-Ping Wang, Troy, MI (US); Michael G. Poss, Rochester Hills, MI (US); Alexander Mepham, Auburn Hills, MI (US); Guangze Li, Novi, MI (US); Eric Gregory Hartnagle, Rochester Hills, MI (US)

(73) Assignee: GM Global Technology Operations LLC, Detroit, MI (US)

(21) Appl. No.: 18/777,203

(22) Filed: Jul. 18, 2024

(51) Int. Cl. H01M 50/503; H01M 50/516

(52) U.S. Cl. CPC H01M 50/503; H01M 50/516

(57) ABSTRACT

A bus bar comprising a first end and a second end spaced from the first end, a first side and a second side spaced from the first side, a first surface extending between the first and second ends and the first and second sides, a second surface extending between the first and second ends and the first and second sides, a thickness between the first surface and the second surface, and a mechanical fuse arranged between the first and second ends and including an upper strength limit.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an electric vehicle and, more particularly, to a bus bar for coupling two or more battery cells.

In general, electric vehicles can be equipped with a battery pack that includes one or more battery cells. Bus bars are commonly used to form a joint between cell terminals of adjacent battery cells. Bus bars provide good electrical connectivity with low resistance and good mechanical strength for maintaining connection during travel. Currently, a collision or impact on one battery cell can result in damage to internal components of a neighboring (i.e., adjacent) battery cell as a result of the bus bar connecting the terminals of the batteries. Shortcomings of existing systems are addressed by one or more aspects of the present disclosure.

### SUMMARY

In one configuration, a bus bar is provided and includes a first end and a second end spaced from the first end, a first side and a second side spaced from the first side, a first surface extending between the first and second ends and the first and second sides, a second surface extending between the first and second ends and the first and second sides, a thickness between the first surface and the second surface, and a mechanical fuse arranged between the first and second ends and including an upper strength limit.

The bus bar may include one or more of the following optional aspects. For example, the mechanical fuse includes one or more through holes extending through the first surface and the second surface.

According to at least one aspect, the mechanical fuse includes a groove extending from the first surface into a portion of the thickness.

According to another aspect, the mechanical fuse includes a necked portion that is arranged laterally between the first end and the second end.

According to at least one example, the mechanical fuse includes one or more notches in the first side between the first end and the second end. The mechanical fuse can further include one or more notches in the second side between the first end and the second end.

According to another example, the bus bar includes a first portion and a second portion, the mechanical fuse being arranged between the first portion and the second portion. The bus bar can be configured to separate along the mechanical fuse when the upper strength limit is met or exceeded.

According to at least one aspect, the mechanical fuse encircles a weldable region of the bus bar.

According to another aspect, the mechanical fuse extends between the first side and the second side.

In another configuration, a battery module is provided and includes one or more battery cells and at least one bus bar communicatively coupled to the one or more battery cells. The at least one bus bar includes a first portion, a second portion, and a mechanical fuse arranged between the first portion and the second portion.

The battery module may include one or more of the following optional aspects. For example, the at least one bus bar couples the one or more battery cells in series.

According to at least one aspect, the at least one bus bar couples the one or more battery cells in parallel.

According to another aspect, the mechanical fuse includes an upper strength limit. The at least one bus bar can be configured to separate along the mechanical fuse when the upper strength limit is met or exceeded.

In yet another configuration, a vehicle is provided and includes a vehicle body, an electric motor coupled to the vehicle body, and a battery pack coupled to the vehicle body and communicatively coupled to the electric motor. The battery pack includes one or more battery modules and each of the one or more battery modules includes one or more battery cells. The one or more battery cells include a main body, including a first end and second end spaced from the first end, one or more side walls extending between the first end and the second end, one or more end walls extending between the first end and the second end, and one or more terminals coupled to and extending away from the first end. The battery cells further include one or more bus bars communicatively coupled to the one or more terminals of the one or more battery cells and including a mechanical fuse that includes an upper strength limit.

The vehicle may include one or more of the following optional aspects. For example, the one or more bus bars are configured to separate along the mechanical fuse when the upper strength limit is met or exceeded.

According to at least one aspect, the one or more battery cells further include at least one weld joint between the one or more bus bars and the one or more terminals. The mechanical fuse can encircle the at least one weld joint.

According to at least one example, the mechanical fuse is arranged between a first portion and a second portion.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a battery pack coupled to a motor according to principles of the present disclosure;

FIG. 2 is a perspective view of a battery module of the battery pack of FIG. 1 including one or more battery cells coupled together with one or more bus bars;

FIG. 3A is a fragmentary top view of a first configuration of a bus bar coupled to a terminal;

FIG. 3B is a cross-sectional view of the first configuration of the bus bar of FIG. 3A along lines 3B-3B;

FIG. 4A is a fragmentary top view of a second configuration of a bus bar coupled to a terminal;

FIG. 4B is a cross-sectional view of the second configuration of the bus bar of FIG. 4A along lines 4B-4B;

FIG. 5A is a fragmentary top view of a third configuration of a bus bar coupled to a terminal;

FIG. 5B is a cross-sectional view of the third configuration of the bus bar of FIG. 5A along lines 5B-5B;

FIG. 6A is a fragmentary top view of a fourth configuration of a bus bar coupled to a terminal;

FIG. 6B is a cross-sectional view of the fourth configuration of the bus bar of FIG. 6A along lines 6B-6B;

FIG. 7A is a fragmentary top view of a fifth configuration of a bus bar coupled to a terminal;

FIG. 7B is a cross-sectional view of the fifth configuration of the bus bar of FIG. 7A along lines 7B-7B;

FIG. 8A is a fragmentary top view of a sixth configuration of a bus bar coupled to a terminal; and

FIG. 8B is a cross-sectional view of the sixth configuration of the bus bar of FIG. 8A along lines 8B-8B.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In general, bus bars are commonly used to communicatively couple terminals of two or more battery cells together. Traditional bus bars provide good electrical conductivity with low resistance and good mechanical strength for maintaining electrical communication between battery cells during travel. However, in the event of a collision or impact to one of the battery cells, the traditional bus bar connection between battery cells can cause damage to cell internals of a neighboring battery cell that would otherwise be unaffected. Damage to cell internals of a battery cell can eventually result in a failure (e.g., thermal runaway) of the affected battery cell. Replacing multiple battery cells can be time consuming and expensive, so mitigating damage to other battery cells during a collision event is desirable. As will be introduced below, a bus bar with a mechanical fuse or sacrificial joint can be desirable for preventing a force from propagating through a battery module or battery pack during a collision event, for example.

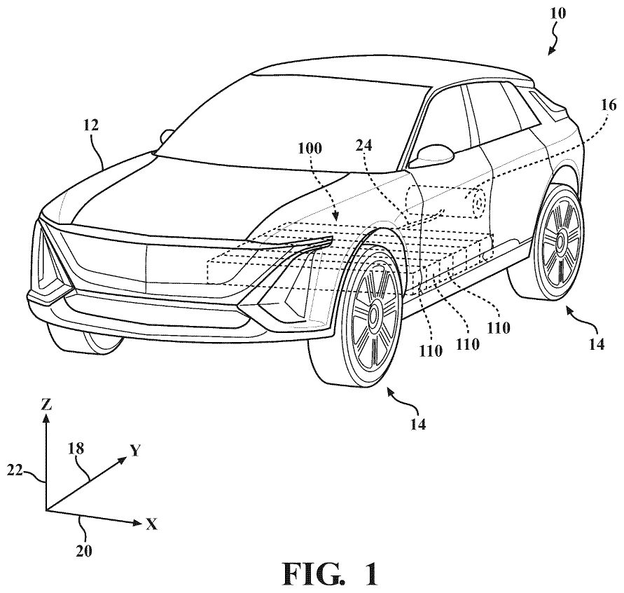

With reference to FIG. 1, an illustrative example of a vehicle 10, such as an electric motor vehicle, is provided. The vehicle 10, includes a vehicle body 12, one or more wheels 14, and an electric motor 16 arranged in and/or coupled to the vehicle body 12. The vehicle body 12 extends along a first or longitudinal axis (i.e., fore-aft direction) 18, a second or lateral axis (i.e., cross-car direction) 20, and a third or vertical axis 22. The electric motor 16 can be configured to drive at least one of the one or more wheels 14 to propel the vehicle 10. The vehicle 10 includes a battery pack 100 that can be arranged in and/or coupled to the vehicle body 12 and is communicatively coupled to the electric motor 16 via an electric power cable 24.

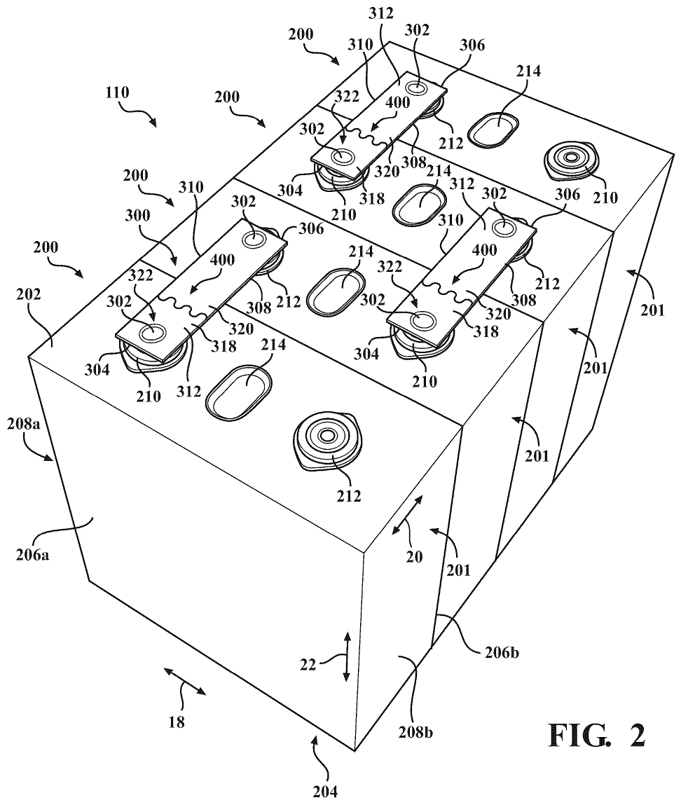

The battery pack 100 can have one or more battery modules 110 that each includes one or more battery cells 200 (FIG. 2). The one or more battery cells 200 can be prismatic battery cells, as shown in FIG. 2. However, the principles of the present disclosure equally apply to other types of battery cells (e.g., pouch cells, cylindrical cells, etc.) as well. The one or more battery cells 200 each includes a main body 201 (e.g., a prismatic can) that is configured to house battery cell internals (e.g., one or more jelly rolls). The main body 201 includes a first or upper end 202 and a second or lower end 204 spaced from the first end 202 with respect to the vertical axis 22. The main body 201 can also include one or more side walls 206a, 206b that extend between the first end 202 and the second end 204 and one or more end walls 208a, 208b that extend between the first end 202 and the second end 204. One or more terminals can be coupled to or arranged at the first end 202 of the main body 201 and communicatively coupled to the cell internals (not shown). For instance, in the present illustrative example, each of the battery cells 200 includes a first or positive terminal 210 and a second or negative terminal 212 spaced from the positive terminal 210 with respect to the longitudinal axis 18. A vent 214 can also be arranged at or coupled to the first end 202 of the main body 201, as shown in FIG. 2.

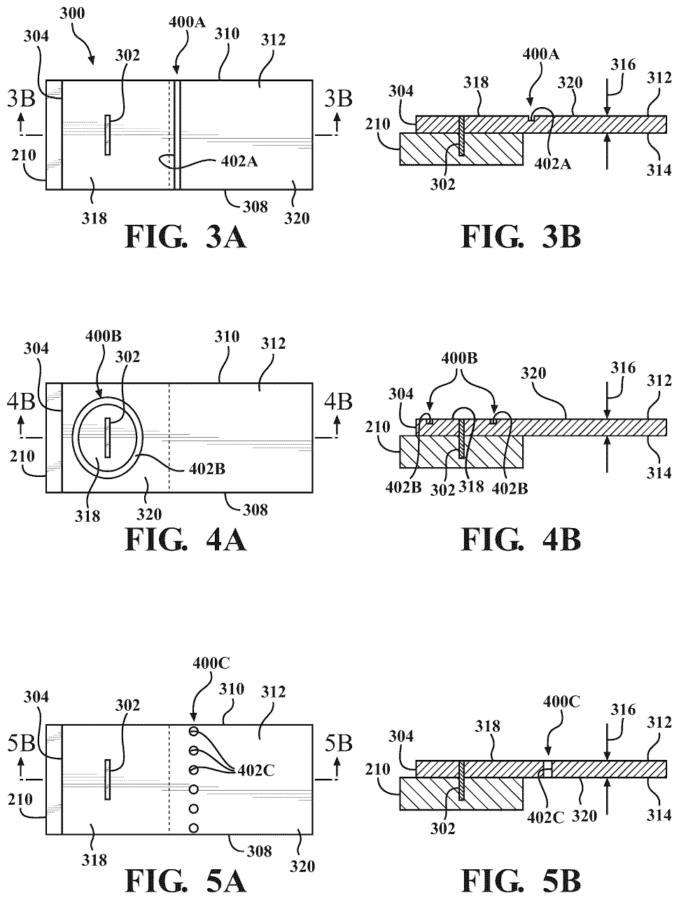

With continued reference to FIG. 2, the one or more battery cells 200 are shown communicatively coupled together by one or more bus bars 300. In the present example, the one or more battery cells 200 are coupled together in series by the one or more bus bars 300. In other words, the one or more bus bars 300 are coupled to the positive terminal 210 of one of the one or more battery cells 200 and to the negative terminal 212 of another of the one or more battery cells 200. In another example, the bus bars 300 can couple the one or more battery cells 200 in parallel. Particularly, the one or more bus bars 300 can be used to couple two or more of the positive terminals 210 together and two or more of the negative terminals 212 together. The bus bars 300 can be welded or otherwise coupled to the positive and/or negative terminals 210, 212. In the present illustrative example, weld joints 302 are formed between the one or more bus bars 300 and the positive and/or negative terminals 210, 212. Various weld patterns may be selected to securely couple the bus bars 300 to the one or more battery cells 200. For instance, the weld joint 302 can be a line (FIGS. 3-8), an s-shape, a c-shape, a circular shape (FIG. 2) or another shape commonly used to couple a bus bar to a battery of an electric vehicle.

In general, as shown in FIG. 2, the one or more bus bars 300 are rectangular. For instance, each of the bus bars 300 includes a first end 304 and a second end 306 spaced from the first end 304, and a first side 308 and a second side 310 spaced from the first side 308. Additionally, the bus bars 300 include a first or upper surface 312 and a second or lower surface 314 (FIGS. 3B-8B) opposite the first surface 312 that each extends between the first and second ends 304, 306 and between the first and second sides 308, 310. A thickness 316 (FIGS. 3B-8B) is arranged between the first surface 312 and the second surface 314. Note, the principles of the present disclosure equally apply to bus bars that are non-rectangular as well.

With reference to FIGS. 2-8, the one or more bus bars 300 each includes a mechanical fuse or sacrificial joint 400 that is configured with a reduced load bearing capability. In general, the mechanical fuse 400 is configured so that the bus bars 300 will fail if a force acts on one of the battery cells 200 as a result of a collision (e.g., with another vehicle, an object, etc.) or otherwise. In other words, the mechanical fuse 400 can be desirable to prevent a force from propagating to and causing damage to cell internals of a neighboring (i.e. adjacent) battery cell, for example. As will be discussed below, each of the mechanical fuses 400 has an upper strength limit so that unnecessary (i.e., premature) failure of the bus bar 300 is avoided when a minor collision or impact occurs during travel or otherwise. When a force acts on the bus bar 300 that meets or exceeds the upper strength limit of the mechanical fuse 400, the bus bar 300 can separate into two or more portions so that electrical communication between neighboring battery cells 200 is terminated and further damage to cell internals of neighboring battery cells 200 is avoided. According to one aspect, the bus bar can include a first portion 318 coupled to the positive terminal 210 and a second portion 320 coupled to another terminal (i.e., positive or negative terminal) of a neighboring battery cell 200. The mechanical fuse can be arranged between the first portion 318 and the second portion 320 and/or with respect to a weldable region 322 of the bus bar 300. According to another aspect, the mechanical fuse 400 can encircle the weldable region 322.

FIGS. 3 through 8 provide illustrative configurations of the bus bar 300 including mechanical fuses 400A-400F. These configurations are similar in many respects to the configuration of FIGS. 1-2. Accordingly, the descriptions of the configurations are hereby incorporated into one another, and description of subject matter common to the configurations generally may not be repeated.

With reference to FIGS. 3A and 3B, a configuration of the bus bar 300 is provided and shown coupled to the positive terminal 210 of the battery cell 200 via the weld joint 302. The bus bar 300 also includes a mechanical fuse 400A that includes a groove 402A that extends between the first side 308 and the second side 310. The groove 402A can include a depth that extends between the first surface 312 and the second surface 314 and a width that extends between the first end 304 and the second end (not shown). The depth and/or width can vary to define the upper strength limit of the bus bar 300. In operation, if a force acts on and exceeds the upper strength limit of the bus bar 300, then the bus bar 300 will split along the mechanical fuse 400A (i.e., along the groove 402A) and any connection between the first portion 318 and the second portion 320 will sever partially or completely.

With reference to FIGS. 4A and 4B, another configuration of the bus bar 300 is provided and shown coupled to the positive terminal 210 of the battery cell 200 via the weld joint 302. The bus bar 300 also includes a mechanical fuse 400B that includes a groove, such as a circular groove 402B that encircles the weld joint 302. The mechanical fuse 400B can be an oval groove, square groove, rectangular groove, or another non-circular shape in other examples as well. The circular groove 402B can include a depth that extends between the first surface 312 and the second surface 314. The depth can vary to define the upper strength limit of the bus bar 300. In operation, if a force acts on and exceeds the upper strength limit of the bus bar 300, then the bus bar 300 will split along the mechanical fuse 400B (i.e., along the circular groove 402B) and any connection between the first portion 318 and the second portion 320 will sever partially or completely.

With reference to FIGS. 5A and 5B, another configuration of the bus bar 300 is provided and shown coupled to the positive terminal 210 of the battery cell 200 via the weld joint 302. The bus bar 300 also includes a mechanical fuse 400C that includes one or more perforations 402C that extend between the first side 308 and the second side 310. The perforations 402C can be arranged laterally between the positive terminal 210 and the negative terminal (not shown). A number of the perforations 402C and/or a pattern of the perforations 402C can vary to define the upper strength limit of the bus bar 300. In operation, if a force acts on and exceeds the upper strength limit of the bus bar 300, then the bus bar 300 will split along the mechanical fuse 400C (i.e., along the perforations 402C) and any connection between the first portion 318 and the second portion 320 will sever partially or completely.

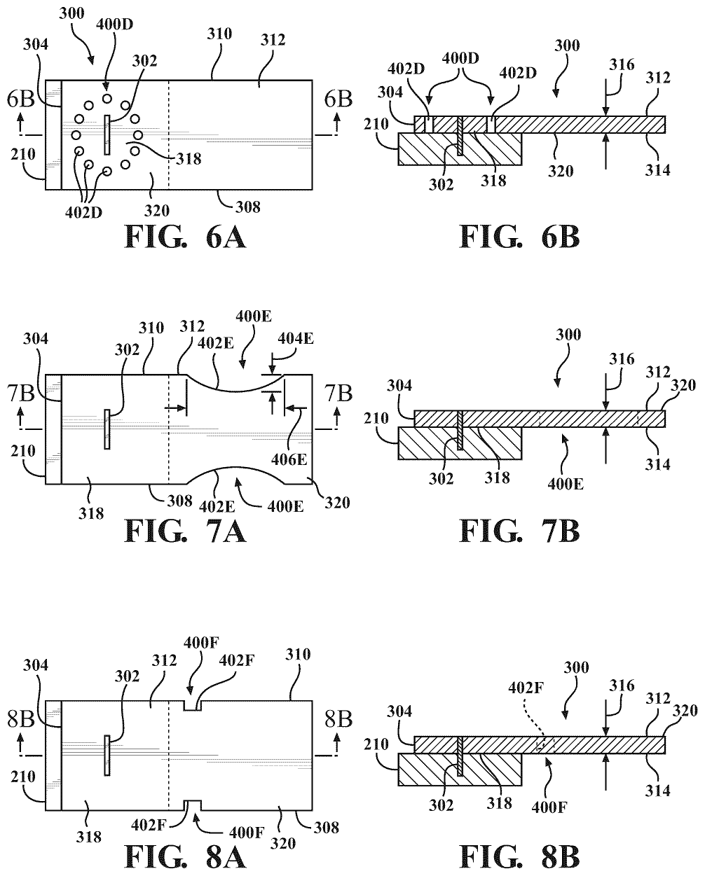

With reference to FIGS. 6A and 6B, another configuration of the bus bar 300 is provided and shown coupled to the positive terminal 210 of the battery cell 200 via the weld joint 302. The bus bar 300 also includes a mechanical fuse 400D that includes a circle of perforations 402D that encircle the weld joint 302. The perforations 402D can be arranged in an oval, square, rectangle, or another non-circular shape as well. The perforations 402D extend through the first surface 312 and the second surface 314. A number of the perforations 402D and/or a pattern of the perforations 402D around the weld joint 302 can vary to define the upper strength limit of the bus bar 300. In operation, if a force acts on and exceeds the upper strength limit of the bus bar 300, then the bus bar 300 will split along the mechanical fuse 400D (i.e., along the perforations 402D) and any connection between the first portion 318 and the second portion 320 will sever partially or completely.

With reference to FIGS. 7A and 7B, another configuration of the bus bar 300 is provided and shown coupled to the positive terminal 210 of the battery cell 200 via the weld joint 302. The bus bar 300 also includes a mechanical fuse 400E that includes a necked portion 402E on the first and second sides 308, 310 of the bus bar 300. The necked portion 402E can be arranged laterally between the positive terminal 210 of one of the one or more battery cells 200 and the negative terminal of another of the one or more battery cells (not shown). Also, the necked portion 402E includes a depth 404E and a width 406E. The depth 404E and the width 406E can vary to define the upper strength limit of the bus bar 300. In operation, if a force acts on and exceeds the upper strength limit of the bus bar 300, then the bus bar 300 will split along the mechanical fuse 400E (i.e., between the necked portions 402E) and any connection between the first portion 318 and the second portion 320 will sever partially or completely.

With reference to FIGS. 8A and 8B, another configuration of the bus bar 300 is provided and shown coupled to the positive terminal 210 of the battery cell 200 via the weld joint 302. The bus bar 300 also includes a mechanical fuse 400F that includes one or more notches 402F on the first and second sides 308, 310 of the bus bar 300. The one or more notches 402F can be arranged laterally between the positive terminal 210 and the negative terminal (not shown). Also, the one or more notches 402F define a notch width 404F that is arranged axially between one or more notches, as shown in FIG. 8A. The notch width 404F can vary to define the upper strength limit of the bus bar 300. In operation, if a force acts on and exceeds the upper strength limit of the bus bar 300, then the bus bar 300 will split along the mechanical fuse 400F (i.e., along the notch width 404F) and any connection between the first portion 318 and the second portion 320 will sever partially or completely.

The mechanical fuses 400A-400F can be included on the bus bar 300 individually, as introduced above, or in combination so that the bus bar 300 is configured with a reduced load bearing capability. The mechanical fuses 400A-400F can be formed using cutting, slitting, etching, drilling, local thinning during forming, or another machining technique commonly used in the automotive industry. In practice, the characteristics of the mechanical fuses 400A-400F such shape, curvature, orientation, size, etc. may vary from what is shown in the illustrative examples above, however, the principles equally apply.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A bus bar, comprising:
a first end and a second end spaced from the first end;
a first side and a second side spaced from the first side;
a first surface extending between the first and second ends and the first and second sides;
a second surface extending between the first and second ends and the first and second sides;
a thickness between the first surface and the second surface; and
a mechanical fuse arranged between the first and second ends and including an upper strength limit.

2. The bus bar of claim 1, wherein the mechanical fuse includes one or more through holes extending through the first surface and the second surface.

3. The bus bar of claim 1, wherein the mechanical fuse includes a groove extending from the first surface into a portion of the thickness.

4. The bus bar of claim 1, wherein the mechanical fuse includes a necked portion that is arranged laterally between the first end and the second end.

5. The bus bar of claim 1, wherein the mechanical fuse includes one or more notches in the first side between the first end and the second end.

6. The bus bar of claim 5, wherein the mechanical fuse includes one or more notches in the second side between the first end and the second end.

7. The bus bar of claim 1, wherein the bus bar comprises a first portion and a second portion, the mechanical fuse being arranged between the first portion and the second portion.

8. The bus bar of claim 7, wherein the bus bar is configured to separate along the mechanical fuse when the upper strength limit is met or exceeded.

9. The bus bar of claim 1, wherein the mechanical fuse encircles a weldable region of the bus bar.

10. The bus bar of claim 1, wherein the mechanical fuse extends between the first side and the second side.

11. A battery module, comprising:
one or more battery cells; and
at least one bus bar communicatively coupled to the one or more battery cells, the at least one bus bar comprising:
a first portion,
a second portion, and
a mechanical fuse arranged between the first portion and the second portion.

12. The battery module of claim 11, wherein the at least one bus bar couples the one or more battery cells in series.

13. The battery module of claim 11, wherein the at least one bus bar couples the one or more battery cells in parallel.

14. The battery module of claim 11, wherein the mechanical fuse includes an upper strength limit.

15. The battery module of claim 14, wherein the at least one bus bar is configured to separate along the mechanical fuse when the upper strength limit is met or exceeded.

16. A vehicle, comprising:
a vehicle body;
an electric motor coupled to the vehicle body;
a battery pack coupled to the vehicle body and communicatively coupled to the electric motor, the battery pack including one or more battery modules, each of the one or more battery modules including one or more battery cells, the one or more battery cells comprising:
a main body, comprising:
a first end and second end spaced from the first end,
one or more side walls extending between the first end and the second end,
one or more end walls extending between the first end and the second end, and
one or more terminals coupled to and extending away from the first end; and
one or more bus bars communicatively coupled to the one or more terminals of the one or more battery cells and including a mechanical fuse that includes an upper strength limit.

17. The vehicle of claim 16, wherein the one or more bus bars are configured to separate along the mechanical fuse when the upper strength limit is met or exceeded.

18. The vehicle of claim 16, wherein the one or more battery cells further include at least one weld joint between the one or more bus bars and the one or more terminals.

19. The vehicle of claim 17, wherein the mechanical fuse encircles the at least one weld joint.

16. ehicle of claim 16, wherein the mechanical fuse is arranged between a first portion and a second portion.
